(19) United States
(12) Patent Application Publication
(10) Pub. No.: US 2026/0183729 A1
(43) Pub. Date: Jul. 2, 2026

(54) Stirrer Assembly

(71) Applicant: KSB SE & CO. KGAA, Frankenthal (DE)

(72) Inventors: Juergen GEINITZ, Frankenthal (DE); Christian THIELEMANN, Frankenthal (DE)

(21) Appl. No.: 18/868,234

(22) PCT Filed: May 16, 2023
(86) PCT No.: PCT/EP2023/063069

§ 371 Date: Nov. 22, 2024

(30) Foreign Application Priority Data
May 25, 2022 (DE) 10 2022 113 277.3

(51) Int. Cl. B01F 35/31; B01F 27/07; B01F 27/25; B01F 35/30; B01F 35/32

(52) U.S. Cl. CPC B01F 35/31; B01F 27/071; B01F 27/25; B01F 35/3204; B01F 2035/352

(57) ABSTRACT

A stirrer assembly includes a shaft, a drive device, a stirring member, and a stirrer stand. The shaft drivable is in rotation about a rotational axis. The drive device is arranged at a first shaft end configured to drive the shaft. The stirring member is arranged rotationally fixedly on the shaft at a second shaft end. The stirrer stand has a supporting device. The stirrer has a housing portion on which a receiving device is provided configured to receive an elastic bearing element. The bearing element rests on the supporting device of the stirrer stand.

### CROSS REFERENCE TO RELATED APPLICATION

This application claims priority under 35 U.S.C. § 119 from German Patent Application No. 10 2022 113 277.3, filed May 25, 2022, the entire disclosure of which is herein expressly incorporated by reference.

### BACKGROUND

The disclosure concerns a stirrer assembly with a shaft drivable in rotation about a rotational axis, a drive device arranged at a first shaft end for driving the shaft, a stirring member arranged rotationally fixedly on the shaft at a second shaft end, and a stirrer stand with a supporting device.

Such stirrers, also known as flow generators, are used in many sectors, e.g. for recirculation of activated sludge in sludge basins, for conveying rainwater, floodwater, surface and polder water, and for generating flow in bodies of water. The stirrers achieve a good flow guidance in the corresponding basins or systems in order to fulfil the respective process object, e.g. good mixing of multiple phases.

The stirrers are usually arranged on a freestanding stirrer stand as known from EP 2 328 676 A1, or fixed to a basin wall by means of a guidance and holding pipe assembly, as known for example from EP 2 659 959 A1. EP 2 689 831 A1 describes a stirrer device arranged on the container cover.

### SUMMARY

The object of the present disclosure is to provide a stirrer assembly in which the forces acting on the stirrer are at least partly transmitted to the stirrer stand, and in the event of service, a simple exchange of the force-transmitting elements is possible.

This object is achieved by a stirrer with the features of claim 1, according to which the stirrer, in particular a submersible motor stirrer, has a housing portion on which a receiving device is provided for receiving an elastic bearing element, wherein the bearing element rests on the supporting device of the stirrer stand.

In an advantageous embodiment, the receiving device comprises a groove base running at least partially radially around the housing portion, and a first radially peripheral groove wall and a second groove wall axially spaced therefrom and running substantially parallel thereto, whereby the bearing element is held in its optimal position, in particular during lowering onto the stirrer stand.

The bearing element is attached to the housing portion by means of at least one connecting device, which additionally ensures that the bearing element is arranged in the optimal position.

Advantageously, the bearing element has a opening close to each connecting device for engagement of a tool, so that the bearing element can be preloaded and brought fully into contact with the groove base before fixing of the connecting devices, preferably in the form of threaded bolts with washers and threaded nuts, or in the form of screws.

In order to transmit the forces occurring at the stirrer particularly well to the stirrer stand, the bearing element comprises elastic materials, preferably rubber or plastic.

Further advantages, features and effects of the present disclosure arise from the following figures. In the drawings:

### BRIEF DESCRIPTION OF THE DRAWINGS

FIG. 1 shows a perspective illustration of the inventive stirrer;

FIG. 2 shows a detail view of the inventive stirrer;

FIG. 3 shows a further detail view of the inventive stirrer; and

FIG. 4 shows a detail view of the inventive stirrer in a sectioned illustration.

### DETAILED DESCRIPTION

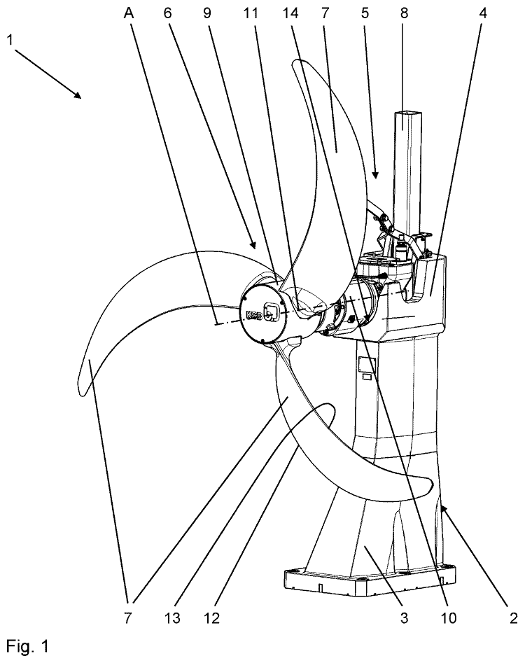

FIG. 1 shows a stirrer assembly 1 with a stirrer stand 2, which in this embodiment variant is produced as an integral concrete or mineral casting and has a foot part 3 and a receiving part 4. The contour of the receiving part 4 is configured such that it can receive a submersible motor stirrer 5 and fix this in its working position.

The submersible motor stirrer 5 has a stirring member 6, here configured as a propeller with three blades 7. A guide member 8, only partially illustrated in FIG. 1, protrudes beyond the stirrer stand 2. This guide member 8, here configured as a steel tube with square cross-section, serves purely to guide the submersible motor stirrer 5 during lowering or withdrawal.

The propeller or stirring member 6 comprises a hub body 9 on which the blades 7 are arranged.

The stirrer 5 has a drive device 10 with a motor and gear mechanism, not shown in detail. A shaft (not shown) is connected by a first shaft end (not shown) to the drive device and can be driven in rotation about a rotational axis A.

The stirring member 6 is rotationally fixedly arranged on the shaft at a second shaft end (not shown). At least two blades 7—three are shown in FIG. 1—are arranged on the hub body 9 and extend from the hub body 9 substantially radially relative to the rotational axis A. Each blade 7 comprises a foot 11 for fastening to the hub body 9. The blades 7 have, substantially in the radial extent, a leading edge region 12 and a trailing edge region 13 opposite the leading edge region 12. The stirring member 6 rotates counterclockwise viewed from the drive device 10.

In the region of the guide member 8, the stirrer stand 2 has known holding devices, not illustrated in detail here, which hold the stirrer 5 in its correct position for operation. The stirrer 5, in particular the receiving part 4, also has a supporting device 14 on which the stirrer 5 rests.

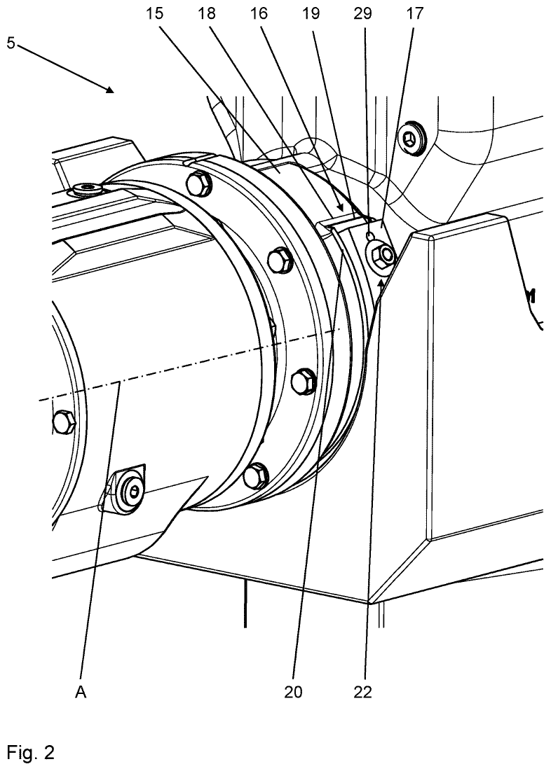

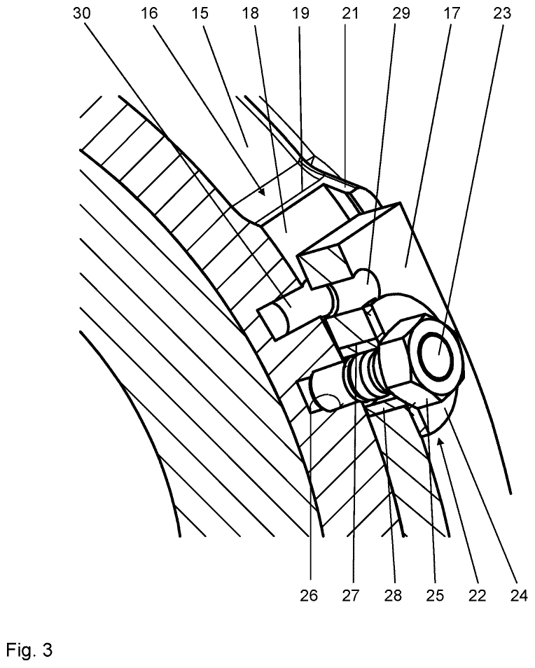

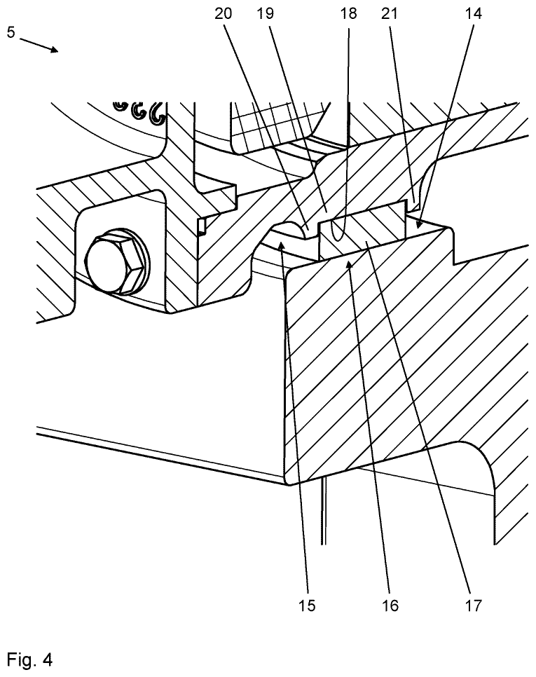

As evident from FIGS. 2 to 4, the stirrer 5 comprises a cylinder-like housing portion 15 on which a groove-like receiving device 16 is provided for receiving an elastic bearing element 17. The receiving device 16 comprises a groove base 18 running at least partially radially around the housing portion 15. In the embodiment shown, the groove base 18 is formed by a shoulder 19 protruding radially relative to the casing surface of the housing portion 15. The receiving device 16 furthermore comprises a first radially peripheral groove wall 20 and a second groove wall 21 axially spaced therefrom and running substantially parallel thereto. The two groove walls 20, 21 protrude from the shoulder 19 substantially over its entire length. The elastic bearing element 17 is arranged between the two groove walls 20, 21 and lies on the groove base 18. To absorb vibrations, the bearing element 17 comprises elastic materials e.g. rubber or plastic.

The bearing element 17 can be fastened to the housing portion 15 in the region of the receiving device 16 by means of at least one connecting device 22 which, in the exemplary embodiment shown, comprises a respective threaded bolt 23 with a washer 24 and a threaded nut 25. The threaded bolt 23 is screwed into a threaded bore 26 provided in the housing portion 15.

A preferably metallic sleeve 28, through which a part of the connecting device 22, in particular the threaded bolt 23, extends, is inserted in a passage bore 27 provided in the bearing element 17. The sleeve 28 ensures that when the threaded nut is tightened, the bearing element 17 is not overly compressed. The sleeve also ensures that the threaded nuts 25 or screws can be tightened to a defined torque.

In the embodiment shown, two connecting devices 22 are provided. In an alternative embodiment (not illustrated), screws are provided as connecting devices.

It is also conceivable that the bearing element 17 runs completely around the housing portion 15 once and is attached to the housing portion 15 solely by means of a connecting device 22.

Close to the connecting devices 22, in fitted state above the connecting devices 22, the bearing element 17 has a opening 29 for engagement of the tool. The tool, which is pushed through the opening 29 in the bearing element 17 and into a bore 30 provided in the housing portion 15, can preload the formed element by levering and hence bring this completely into contact with the groove base 18 before the threaded nuts 25 are tightened.

The bearing element 17 lies on the supporting device 15 of the stirrer stand 2, in particular the receiving part 4. The supporting device 14 has a substantially semicircular form.

Depending on the diameter of the housing portion 15, the shoulder 19 may have a greater or smaller radial extent perpendicular to the rotational axis, so that the rotational axis A of the stirrer 5 is oriented substantially horizontally. In alternative embodiments, the groove base 18 and the two groove walls 20, 22 may be formed at least partially by a recess in the housing portion 15, in particular in its casing surface.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-5. (canceled)

6. A stirrer assembly comprising:
a shaft drivable in rotation about a rotational axis;
a drive device arranged at a first shaft end configured to drive the shaft;
a stirring member arranged rotationally fixedly on the shaft at a second shaft end, and
a stirrer stand having a supporting device, wherein
the stirrer has a housing portion on which a receiving device is provided configured to receive an elastic bearing element, and
the bearing element rests on the supporting device of the stirrer stand.

7. The stirrer assembly as claimed in claim 6, wherein the receiving device comprises a groove base running at least partially radially around the housing portion, and a first radially peripheral groove wall and a second groove wall axially spaced therefrom and running substantially parallel thereto.

8. The stirrer assembly as claimed in claim 7, wherein the bearing element is attached to the housing portion via at least one connecting device.

9. The stirrer assembly as claimed in claim 8, wherein the bearing element has an opening adjacent to each connecting device configured to engage a tool.

10. The stirrer assembly as claimed in claim 6, wherein the bearing element comprises rubber elastic materials, or plastic elastic materials.
